(19) United States
(12) Patent Application Publication
(10) Pub. No.: US 2021/0312568 A1
(43) Pub. Date: Oct. 7, 2021

(54) SYSTEMS AND METHODS FOR VEHICLE INTAKE FOR DAMAGED VEHICLES

(71) Applicant: Mitchell International, Inc., San Diego, CA (US)

(72) Inventors: Hassane Alami, San Diego, CA (US); Mitul Shah, San Diego, CA (US); Sanjeev Kumar, San Diego, CA (US); Umberto Laurent Cannarsa, San Diego, CA (US); John Anthony Bachman, San Diego, CA (US); Daniel Jake Kovar, San Diego, CA (US)

(73) Assignee: Mitchell International, Inc., San Diego, CA (US)

(21) Appl. No.: 17/353,638

(22) Filed: Jun. 21, 2021

Related U.S. Application Data
(63) Continuation-in-part of application No. 16/823,107, filed on Mar. 18, 2020.
Application No. 16/823,107 is a continuation-in-part of application No. 16/827,628, filed on Mar. 23, 2020.
(60) Provisional application No. 62/904,402, filed on Sep. 23, 2019.

(51) Int. Cl. G06Q 40/08; G06K 9/00; G06N 20/00; G06F 16/583

(52) U.S. Cl. CPC G06Q 40/08; G06K 9/00456; G06K 9/00624; G06K 2209/15; G06F 16/5846; G06K 2209/01; G06N 20/00

(57) ABSTRACT

In general, one aspect disclosed features a computer-implemented method comprising: obtaining an image related to a damaged vehicle; determining an image type of the image, wherein the image type describes an item contained in the image; extracting one or more images of text from the image; extracting one or more text strings from each image of text; identifying a type of each text string based on the determined image type; obtaining a record, and for each text string: selecting a field of the record based on the identified type of the text string, and populating the selected field with the text string; and determining an identity of the damaged vehicle based on the populated record.

### CROSS REFERENCE TO RELATED APPLICATIONS

The present application is a continuation-in-part of U.S. patent application Ser. No. 16/823,107, filed Mar. 18, 2020, entitled “METHODS FOR MANAGING REPAIR OF VEHICLE DAMAGE WITH HEAD MOUNTED DISPLAY DEVICE AND DEVICES THEREOF,” which claims priority to U.S. Provisional Patent Application No. 62/904,402, filed Sep. 23, 2019, entitled “METHODS FOR MANAGING REPAIR OF VEHICLE DAMAGE WITH HEAD MOUNTED DISPLAY DEVICE AND DEVICES THEREOF.”

The present application is a continuation-in-part of U.S. patent application Ser. No. 16/827,628, filed Mar. 23, 2020, entitled “METHODS FOR AUTOMATING CUSTOMER AND VEHICLE DATA INTAKE USING WEARABLE COMPUTING DEVICES.”

The disclosures of the above-listed applications are incorporated by reference herein in their entirety.

### TECHNICAL FIELD

The present disclosure is generally related to automobiles. More particularly, the present disclosure is directed to automotive repair technology.

### BACKGROUND

Conventional processing of automobile insurance claims starts with vehicle intake, which is the process of obtaining information regarding the automobile and the owner. Vehicle intake is the collection of information concerning the vehicle, the owner, and the vehicle insurance. Historically this process was entirely manual. Today, even with existing tools, this process remains largely manual, and therefore time-consuming and error-prone.

### SUMMARY

In general, one aspect disclosed features a computer-implemented method comprising: obtaining an image related to a damaged vehicle; determining an image type of the image, wherein the image type describes an item contained in the image; extracting one or more images of text from the image; extracting one or more text strings from each image of text; identifying a type of each text string based on the determined image type; obtaining a record, and for each text string: selecting a field of the record based on the identified type of the text string, and populating the selected field with the text string; and determining an identity of the damaged vehicle based on the populated record.

Embodiments of the method may include one or more of the following features. Some embodiments comprise obtaining insurance claim information for the damaged vehicle based on the determined identity of the damaged vehicle. Some embodiments comprise obtaining repair procedures for the damaged vehicle based on the determined identity of the damaged vehicle. In some embodiments, the determined image type indicates the item is an insurance document; and the method further comprises: indexing a data dictionary with a test keyword comprising at least one of the text strings, wherein the data dictionary contains associations between keywords and names of insurance carriers, and identifying an insurance carrier based on output generated by the data dictionary responsive to the indexing. In some embodiments, the determined image type indicates the item is an insurance document; the one or more text strings comprise multiple text strings; and the method further comprises: identifying a text string as containing a predetermined keyword, determining a distance and/or direction from the identified text string to other text strings, selecting a text string based on at least one of:

the distance and/or direction, and the number of characters in the text string being below a threshold number; and identifying an insurance policy number in the selected text string. In some embodiments, the determined image type indicates the item is an insurance document; the one or more text strings comprise multiple text strings; and the method further comprises: identifying a text string as containing a predetermined keyword, determining a distance and/or direction from the identified text string to other text strings, selecting a text string based on at least one of: the distance and/or direction, and the number of characters in the text string being above a threshold number; and identifying a vehicle identification number in the selected text string. In some embodiments, the determined image type indicates the item is a license plate; the one or more text strings comprise multiple text strings; and the method further comprises: determining sizes of characters in the multiple text strings, selecting text strings having the largest character size, and obtaining a license plate number by concatenating the selected text strings. In some embodiments, the determined image type indicates the item is an odometer; the one or more text strings comprise multiple text strings; and the method further comprises: identifying one of the text strings as representing a measure of distance, selecting the text string nearest in the image to the identified text string, and

obtaining a mileage from the identified and selected text strings. In some embodiments, determining the image type of the image comprises: providing the image as input to a machine learning model, wherein the machine learning model has been trained with images and corresponding image types; and receiving output of the machine learning model responsive to the input, wherein the output comprises the determined image type of the image.

In general, one aspect disclosed features a system, comprising: a hardware processor; and a system encoded with instructions executable by the hardware processor to perform operations comprising: obtaining an image related to a damaged vehicle; determining an image type of the image, wherein the image type describes an item contained in the image; extracting one or more images of text from the image; extracting one or more text strings from each image of text; identifying a type of each text string based on the determined image type; obtaining a record, and for each text string: selecting a field of the record based on the identified type of the text string, and populating the selected field with the text string; and determining an identity of the damaged vehicle based on the populated record.

Embodiments of the system may include one or more of the following features. In some embodiments, the operations further comprise: obtaining insurance claim information for the damaged vehicle based on the determined identity of the damaged vehicle. In some embodiments, the operations further comprise: obtaining repair procedures for the damaged vehicle based on the determined identity of the damaged vehicle. In some embodiments, the determined image type indicates the item is an insurance document; and the operations further comprise: indexing a data dictionary with a test keyword comprising at least one of the text strings, wherein the data dictionary contains associations between keywords and names of insurance carriers, and identifying an insurance carrier based on output generated by the data dictionary responsive to the indexing. In some embodiments, the determined image type indicates the item is an insurance document; the one or more text strings comprise multiple text strings; and the operations further comprise: identifying a text string as containing a predetermined keyword, determining a distance and/or direction from the identified text string to other text strings, selecting a text string based on at least one of: the distance and/or direction, and the number of characters in the text string being below a threshold number; and identifying an insurance policy number in the selected text string. In some embodiments, the determined image type indicates the item is an insurance document; the one or more text strings comprise multiple text strings; and the operations further comprise: identifying a text string as containing a predetermined keyword, determining a distance and/or direction from the identified text string to other text strings, selecting a text string based on at least one of: the distance and/or direction, and the number of characters in the text string being above a threshold number; and identifying a vehicle identification number in the selected text string. In some embodiments, the determined image type indicates the item is a license plate; the one or more text strings comprise multiple text strings; and the operations further comprise: determining sizes of characters in the multiple text strings, selecting text strings having the largest character size, and obtaining a license plate number by concatenating the selected text strings. In some embodiments, the determined image type indicates the item is an odometer; the one or more text strings comprise multiple text strings; and the operations further comprise: identifying one of the text strings as representing a measure of distance, selecting the text string nearest in the image to the identified text string, and obtaining a mileage from the identified and selected text strings. In some embodiments, determining the image type of the image comprises: providing the image as input to a machine learning model, wherein the machine learning model has been trained with images and corresponding image types; and receiving output of the machine learning model responsive to the input, wherein the output comprises the determined image type of the image.

In general, one aspect disclosed features a non-transitory machine-readable storage medium encoded with instructions executable by a hardware processor of a computing component, the machine-readable storage medium comprising instructions to cause the hardware processor to perform operations comprising: obtaining an image related to a damaged vehicle; determining an image type of the image, wherein the image type describes an item contained in the image; extracting one or more images of text from the image; extracting one or more text strings from each image of text; identifying a type of each text string based on the determined image type; obtaining a record, and for each text string: selecting a field of the record based on the identified type of the text string, and populating the selected field with the text string; and determining an identity of the damaged vehicle based on the populated record.

Embodiments of the non-transitory machine-readable storage medium may include one or more of the following features. In some embodiments, the operations further comprise: obtaining insurance claim information for the damaged vehicle based on the determined identity of the damaged vehicle. In some embodiments, the operations further comprise: obtaining repair procedures for the damaged vehicle based on the determined identity of the damaged vehicle. In some embodiments, the determined image type indicates the item is an insurance document; and the operations further comprise: indexing a data dictionary with a test keyword comprising at least one of the text strings, wherein the data dictionary contains associations between keywords and names of insurance carriers, and identifying an insurance carrier based on output generated by the data dictionary responsive to the indexing. In some embodiments, the determined image type indicates the item is an insurance document; the one or more text strings comprise multiple text strings; and the operations further comprise: identifying a text string as containing a predetermined keyword, determining a distance and/or direction from the identified text string to other text strings, selecting a text string based on at least one of: the distance and/or direction, and the number of characters in the text string being below a threshold number; and identifying an insurance policy number in the selected text string. In some embodiments, the determined image type indicates the item is an insurance document; the one or more text strings comprise multiple text strings; and the operations further comprise: identifying a text string as containing a predetermined keyword, determining a distance and/or direction from the identified text string to other text strings, selecting a text string based on at least one of: the distance and/or direction, and the number of characters in the text string being above a threshold number; and identifying a vehicle identification number in the selected text string. In some embodiments, the determined image type indicates the item is a license plate; the one or more text strings comprise multiple text strings; and the operations further comprise: determining sizes of characters in the multiple text strings, selecting text strings having the largest character size, and obtaining a license plate number by concatenating the selected text strings. In some embodiments, the determined image type indicates the item is an odometer; the one or more text strings comprise multiple text strings; and the operations further comprise: identifying one of the text strings as representing a measure of distance, selecting the text string nearest in the image to the identified text string, and obtaining a mileage from the identified and selected text strings. In some embodiments, determining the image type of the image comprises: providing the image as input to a machine learning model, wherein the machine learning model has been trained with images and corresponding image types; and receiving output of the machine learning model responsive to the input, wherein the output comprises the determined image type of the image.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a vehicle repair management system according to some embodiments of the disclosed technology.

FIG. 2 illustrates a process for vehicle intake and repair according to some embodiments of the disclosed technology.

FIG. 3 is a flowchart illustrating a computer-implemented method for vehicle intake for damaged vehicles according to some embodiments of the disclosed technologies.

FIG. 4 is a flowchart illustrating a computer-implemented method for identifying an insurance carrier based on an image having an image type of insurance document according to some embodiments of the disclosed technologies.

FIG. 5 is a flowchart illustrating a computer-implemented method for identifying an insurance policy number based on an image having an image type of insurance document according to some embodiments of the disclosed technologies.

FIG. 6 is a flowchart illustrating a computer-implemented method for identifying an vehicle identification number (VIN) based on an image having an image type of insurance document according to some embodiments of the disclosed technologies.

FIG. 7 is a flowchart illustrating a computer-implemented method for license plate number an insurance policy number based on an image having an image type of license plate according to some embodiments of the disclosed technologies.

FIG. 8 is a flowchart illustrating a computer-implemented method for identifying mileage of a vehicle based on an image having an image type of odometer according to some embodiments of the disclosed technologies.

FIG. 9 is a first example image of a dashboard.

FIG. 10 is a first example image of a dashboard.

FIG. 11 is an example computing component that may be used to implement various features of embodiments described in the present disclosure.

The figures are not exhaustive and do not limit the present disclosure to the precise form disclosed.

### DETAILED DESCRIPTION

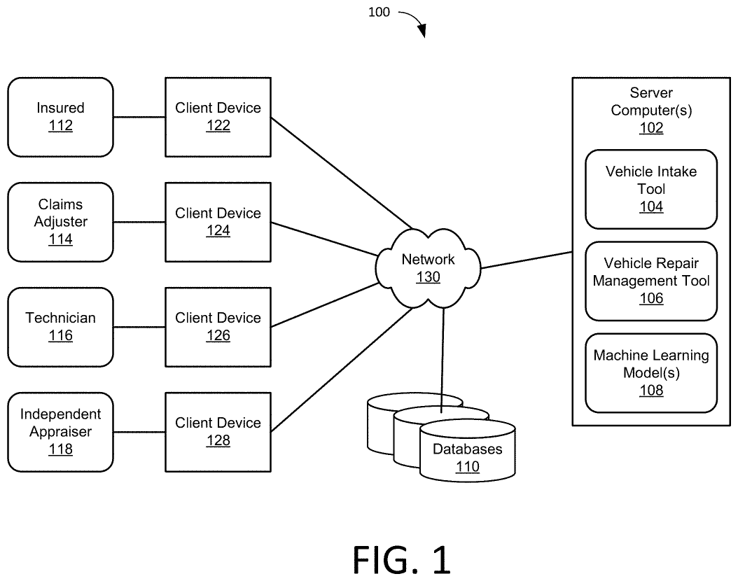

Embodiments of the disclosed technology provide improved systems and methods for vehicle intake for damaged automobiles. But while described with reference to automobiles, the disclosed technology applies to other vehicles and items. FIG. 1 illustrates a vehicle repair management system 100 according to some embodiments of the disclosed technology. Referring to FIG. 1, the system 100 may include one or more server computers 102. The server computer(s) 102 may host a vehicle intake tool 104 for performing tasks such as obtaining information concerning the vehicle, the owner of the vehicle, and the insurance policy for the vehicle based on images such as photos of the vehicle and documents such as insurance documents. The server computer(s) 102 may host a vehicle repair management tool 106 for performing tasks such as generating vehicle repair estimates and obtaining vehicle repair procedures. The server computer(s) 102 may host one or more machine learning models 108 for performing tasks such as determining types of the images, as described below.

Each of the vehicle intake tool 104, the vehicle repair management tool 106, and the machine learning model(s) 108 may be implemented as one or more software packages executing on the server computer(s) 102. The system may include one or more databases 110, which may store intake data, data dictionaries, completed estimates, estimates in process, data regarding parts, part costs, labor, labor costs, and the like. The vehicle repair management system 100 may include additional elements, for example such as those described in U.S. patent application Ser. Nos. 16/823,107 and 16/827,628, the disclosures thereof incorporated by reference herein.

Multiple users may be involved in the estimating method. For example, users may include the insured 112, a claims adjuster 114, a technician 116 such as an employee of a repair shop, an independent appraiser 118, and the like. Each user may access the tools 104, 106 over the network 130 using a respective client device 122, 124, 126, 128. Each client device may be implemented as a desktop computer, laptop computer, smart phone, wearable devices such as head-mounted display devices and smart glasses, embedded computers and displays, diagnostic devices and the like. In some embodiments, the wearable devices may include a transparent heads-up display (HUD) or an optical head-mounted display (OHMD).

In some embodiments, the client devices may include one or more components coupled together by a bus or other communication link, although other numbers and/or types of network devices could be used. For example, the client devices may include a processor, a memory, a display (e.g., OHMD), an input device (e.g., a voice/gesture activated control input device), an output device (e.g., a speaker), an image capture device configured to capture still images and videos, and a communication interface.

In some embodiments, the client devices may present content (e.g., repair procedures) to a user and receive user input (e.g., voice commands). For example, the client device may include a display device, as alluded to above, incorporated in a lens or lenses, and an input device, such as interactive buttons and/or a voice or gesture activated control system to detect and method voice/gesture commands. The display device may be configured to display the repair procedures for facilitating a handsfree and voice- and/or gesture-assisted repair of damage to an automobile, including post-repair assessment.

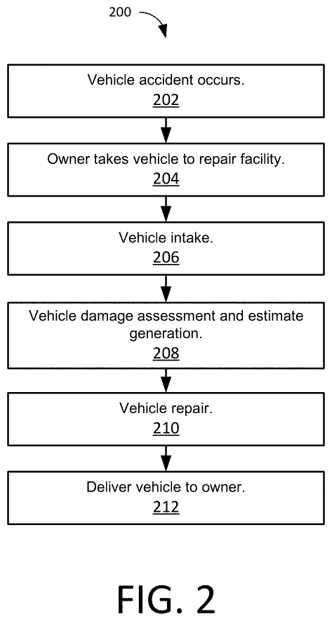

FIG. 2 illustrates a process 200 for vehicle intake and repair according to some embodiments of the disclosed technology. The elements of the disclosed processes are presented in a particular order. However, it should be understood that, in various embodiments, one or more elements may be performed in a different order, in parallel, or omitted. Referring to FIG. 2, the process 200 may begin with a vehicle accident, at 202, and may continue with the vehicle owner taking the vehicle to a repair facility, at 204. The repair facility may perform vehicle intake, at 206, for example as described below.

Next, vehicle damage assessment and estimate generation may be performed, at 208. For example, a staff appraiser of an insurance company may visit the damaged vehicle to take photos of the damage. Alternatively, technicians at the auto repair shop may assess the damage and generate the estimate. Repair of the vehicle may be performed, at 210, and on completion of the repair the repaired vehicle may be delivered to the vehicle owner, at 212.

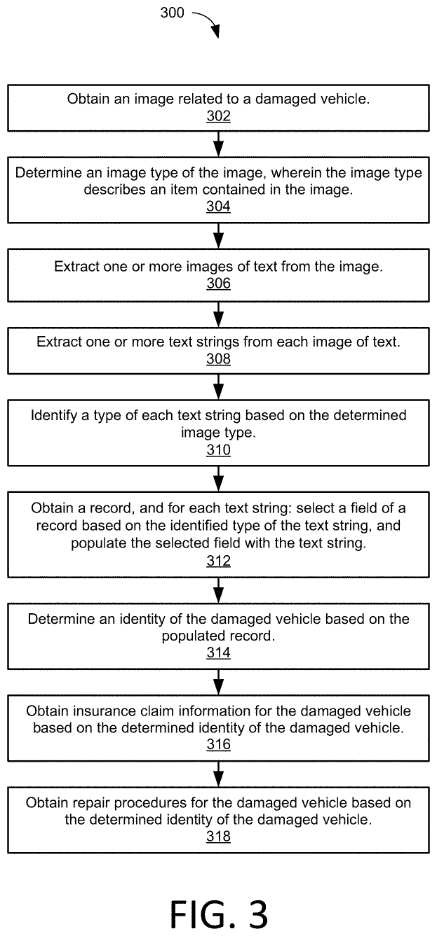

FIG. 3 is a flowchart illustrating a computer-implemented method 300 for vehicle intake for damaged vehicles according to some embodiments of the disclosed technologies. For example, the method 300 may be implemented in the vehicle repair management system 100 of FIG. 1. Execution of the method may be performed by the computing devices of FIG. 1, operating alone or in any combination.

The elements of the method 300 are presented in one arrangement. However, it should be understood that one or more elements of the method may be performed in a different order, in parallel, omitted entirely, and the like. Furthermore, the method 300 may include other elements in addition to those presented. For example, the method 300 may include error-handling functions if exceptions occur, and the like.

Referring to FIG. 3, the method 300 may include obtaining an image related to a damaged vehicle, at 302. In the example of FIG. 1, the image may be captured by any of the client devices. For example, the image may be captured at a repair facility by the client device 126 of the technician 116. In some embodiments, the vehicle intake tool 104 may provide instructions to the technician 116 via the client device 126 to capture images of certain portions of the vehicle and certain documents, for example such as the dashboard, license plate, damaged areas, insurance card, drivers license, license plate. In some embodiments, the technician 116 may simply follow a predefined script to capture the images. For example, the script may specify capturing video of the entire exterior of the vehicle as well as the dashboard. However, the technician 116 is not instructed or required to identify the contents of the images being captured. Instead, the vehicle intake tool 104 automatically identifies the contents of the images being captured, as described in detail herein. The captured images may be stored in any of the server computer(s) 102, the databases 110, and the client devices 122, 124, 126, and 128.

Referring again to FIG. 3, the method 300 may include determining an image type of the image, wherein the image type describes an item contained in the image, at 304. For example, the items may include a license plate of the vehicle, an odometer of the vehicle, an insurance document, a driver's license, and similar items. The method 300 may include extracting one or more images of text from the image, at 306. Referring to FIG. 1, in some embodiments, the image may be sent to the machine learning model 108, which may determine the image type and extract the images of text. The machine learning model 108 may have been trained with images and corresponding image types, using supervised learning techniques, unsupervised learning techniques, or both. Responsive to the input, the machine learning model 108 may output a determined image type of the image and the image(s) of the text string(s). In some embodiments, the determined image type may be sent to the client device 126 for display to the technician 116.

Referring again to FIG. 3, the method 300 may include extracting one or more text strings from each image of text, at 308. For example, the text string(s) may be extracted from the image(s) of text by applying conventional optical character recognition (OCR) technologies. The OCR may be applied by one of the computing devices of the vehicle repair management system 100, by an external system, or by a combination thereof.

Referring again to FIG. 3, the method 300 may include identifying a type of each text string based on the determined image type, at 310. Methods for identifying types of text strings based on image type are described in detail below. The extracted text strings may include, by way of non-limiting examples, a license plate number, a VIN number, an insurance policy number, an insurance carrier, a driver's license number, or a mileage.

Referring again to FIG. 3, the method 300 may include obtaining a record, and for each text string: selecting a field of the record based on the identified type of the text string, and populating the selected field with the text string, at 312. For example, the record may be an insurance claim record, and the proper fields may be populated with the license plate number, VIN number, insurance policy number, insurance carrier, driver's license number, and/or mileage.

Referring again to FIG. 3, the method 300 may include determining an identity of the damaged vehicle based on the populated record, at 314. Continuing the above example, the identity of the damaged vehicle may be determined based on the populated fields of the insurance claim record, for example such as the VIN.

Referring again to FIG. 3, the method 300 may include obtaining insurance claim information for the damaged vehicle based on the determined identity of the damaged vehicle, at 316. In some embodiments, the insurance claim information may be obtained manually in a conventional manner. In some embodiments, the insurance claim information may be obtained automatically. In the example of FIG. 1, the vehicle intake tool 104 may transmit a populated insurance claim record over the network 130 to a server of the insurance carrier identified in the populated insurance claim record. Responsive to receiving the populated insurance claim record, the server of the insurance carrier may transmit information over the network 130 to the vehicle intake tool 104. The transmitted information may include a confirmation of the existence of the insurance policy, whether the identified vehicle is covered by the policy, the expiration date of the policy, coverages, coverage limits, and other information concerning the insurance policy. In some embodiments, the insurance claim information may be obtained and processed as described in U.S. patent application Ser. No. 16/827,628, filed Mar. 23, 2020, the disclosure thereof incorporated by reference herein in its entirety.

Referring again to FIG. 3, the method 300 may include obtaining repair procedures for the damaged vehicle based on the determined identity of the damaged vehicle, at 318. In some embodiments, the repair procedures may be obtained manually in a conventional manner. In some embodiments, the repair procedures may be obtained automatically. In the example of FIG. 1, the databases 110 may include repair procedures for damaged vehicles. These repair procedures are guides to proper methods of repairing the vehicles, and may be published by OEMs, insurance companies, and other aftermarket data suppliers. The repair procedures explain the various steps and actions that need to be taken to repair the vehicle, and identify the required tools and materials. The vehicle repair management tool 106 may index the databases 110 using the populated insurance claim record to obtain the repair procedures. The vehicle repair management tool 106 may index the databases 110 using additional information to enable obtaining repair procedures for the damaged vehicle. This additional information may include information provided by the technician 116, such as vehicle diagnostic codes and similar information. This additional information may also include information derived from images of the damaged vehicle. This information may be derived from images of the damaged vehicle, for example, as described in U.S. patent application Ser. No. 16/929,984, filed Jul. 15, 2020 and U.S. patent application Ser. No. 16/998,948, filed Aug. 20, 2020, the disclosures thereof incorporated by reference herein in their entirety. In some embodiments, the repair procedures may be obtained and processed as described in U.S. patent application Ser. No. 16/823,107, filed Mar. 18, 2020, the disclosure thereof incorporated by reference herein in its entirety.

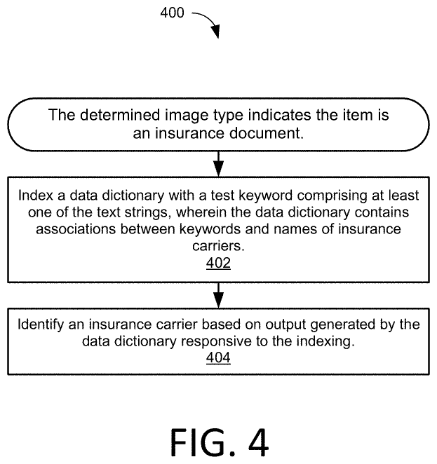

FIG. 4 is a flowchart illustrating a computer-implemented method 400 for identifying an insurance carrier based on an image having an image type of insurance document according to some embodiments of the disclosed technologies. For example, the method 400 may be implemented in the vehicle repair management system 100 of FIG. 1. Execution of the method may be performed by the computing devices of FIG. 1, operating alone or in any combination.

The elements of the method 400 are presented in one arrangement. However, it should be understood that one or more elements of the method may be performed in a different order, in parallel, omitted entirely, and the like. Furthermore, the method 400 may include other elements in addition to those presented. For example, the method 400 may include error-handling functions if exceptions occur, and the like.

Referring to FIG. 4, the method 400 may include indexing a data dictionary with a test keyword comprising at least one of the text strings, at 402. The data dictionary may contains associations between keywords and names of insurance carriers. In the example of FIG. 1, the data dictionary may reside in the databases 110.

Referring again to FIG. 4, the method 400 may include identifying an insurance carrier based on output generated by the data dictionary responsive to the indexing, at 404. For example, the text string may include all or part of the name of an insurance carrier. Responsive to being indexed by the test keyword, the data dictionary may output a string representing the name of an insurance carrier associated with a keyword corresponding to the test keyword.

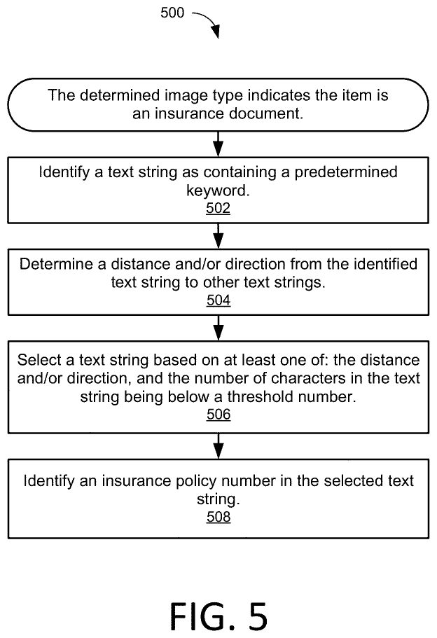

FIG. 5 is a flowchart illustrating a computer-implemented method 500 for identifying an insurance policy number based on an image having an image type of insurance document according to some embodiments of the disclosed technologies. For example, the method 500 may be implemented in the vehicle repair management system 100 of FIG. 1. Execution of the method may be performed by the computing devices of FIG. 1, operating alone or in any combination.

The elements of the method 500 are presented in one arrangement. However, it should be understood that one or more elements of the method may be performed in a different order, in parallel, omitted entirely, and the like. Furthermore, the method 500 may include other elements in addition to those presented. For example, the method 500 may include error-handling functions if exceptions occur, and the like.

Referring to FIG. 5, the method 500 may include identifying a text string as containing a predetermined keyword, at 502. In this example, the predetermined keywords may include words such as “Policy”, “Number”, “No.”, and the like, and combinations thereof.

The method 500 may include determining a distance and/or direction from the identified text string to other text strings extracted from the image, at 504, and selecting a text string based on at least one of: the distance and/or direction, and the number of characters in the text string being below a threshold number, at 506. For example, when a string includes the keywords “Policy” and “No.”, it is highly likely that the closest string to the right of that string contains the insurance policy number. Furthermore, most insurance policy numbers are fewer than 15 characters in length. Therefore the method may include selecting the string that is fewer than 15 characters in length and is closest to the right of the string identified as containing a predetermined keyword. The method 500 may include identifying an insurance policy number in the selected text string, at 508.

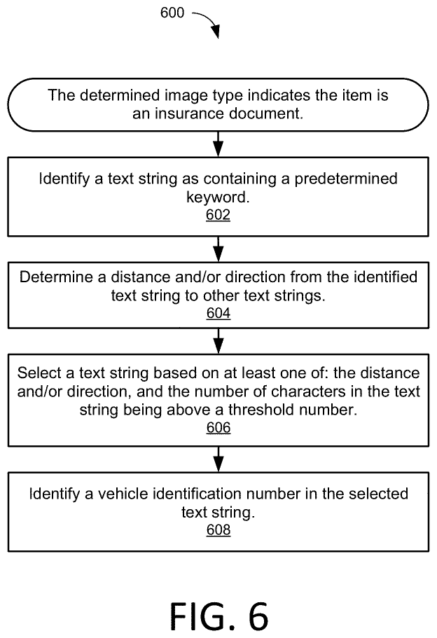

FIG. 6 is a flowchart illustrating a computer-implemented method 600 for identifying a vehicle identification number (VIN) based on an image having an image type of insurance document according to some embodiments of the disclosed technologies. For example, the method 600 may be implemented in the vehicle repair management system 100 of FIG. 1. Execution of the method may be performed by the computing devices of FIG. 1, operating alone or in any combination.

The elements of the method 600 are presented in one arrangement. However, it should be understood that one or more elements of the method may be performed in a different order, in parallel, omitted entirely, and the like. Furthermore, the method 600 may include other elements in addition to those presented. For example, the method 600 may include error-handling functions if exceptions occur, and the like.

Referring to FIG. 6, the method 600 may include identifying a text string as containing a predetermined keyword, at 602. In this example, the predetermined keywords may include words such as “VIN” and the like, and combinations thereof.

The method 600 may include determining a distance and/or direction from the identified text string to other text strings extracted from the image, at 604, and selecting a text string based on at least one of: the distance and/or direction, and the number of characters in the text string being above a threshold number, at 606. For example, when a string includes the keyword “VIN”, it is highly likely that the closest string to the right of that string contains the insurance policy number. Furthermore, most VINs are greater than 15 characters in length. Therefore the method may include selecting the string that is greater than 15 characters in length and is closest to the right of the string identified as containing a predetermined keyword. The method 600 may include identifying a VIN in the selected text string, at 608. The method may include removing any extraneous characters preceding or following the VIN.

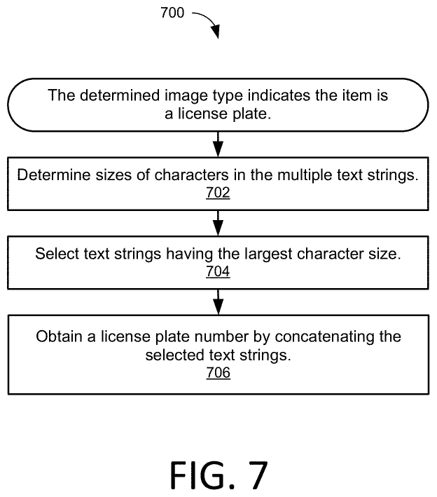

FIG. 7 is a flowchart illustrating a computer-implemented method 700 for identifying a license plate number based on an image having an image type of license plate according to some embodiments of the disclosed technologies. For example, the method 700 may be implemented in the vehicle repair management system 100 of FIG. 1. Execution of the method may be performed by the computing devices of FIG. 1, operating alone or in any combination.

The elements of the method 700 are presented in one arrangement. However, it should be understood that one or more elements of the method may be performed in a different order, in parallel, omitted entirely, and the like. Furthermore, the method 700 may include other elements in addition to those presented. For example, the method 700 may include error-handling functions if exceptions occur, and the like.

Referring to FIG. 7, the method 700 may include obtaining multiple text strings from the image, and determining sizes of characters in the multiple text strings, at 702. The largest characters in an image of a license plate generally represent the license plate number. The method 700 may include selecting text strings having the largest character size, at 704. In many license plates, the license plate number includes two strings separated by a space, symbol, or the like. The method 700 may include obtaining a license plate number by concatenating the selected text strings when there are multiple text strings having the largest character size, at 706.

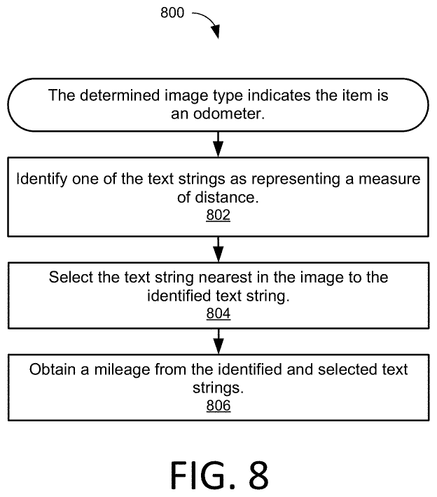

FIG. 8 is a flowchart illustrating a computer-implemented method 800 for identifying mileage of a vehicle based on an image having an image type of odometer according to some embodiments of the disclosed technologies. For example, the method 800 may be implemented in the vehicle repair management system 100 of FIG. 1. Execution of the method may be performed by the computing devices of FIG. 1, operating alone or in any combination.

The elements of the method 800 are presented in one arrangement. However, it should be understood that one or more elements of the method may be performed in a different order, in parallel, omitted entirely, and the like. Furthermore, the method 800 may include other elements in addition to those presented. For example, the method 800 may include error-handling functions if exceptions occur, and the like.

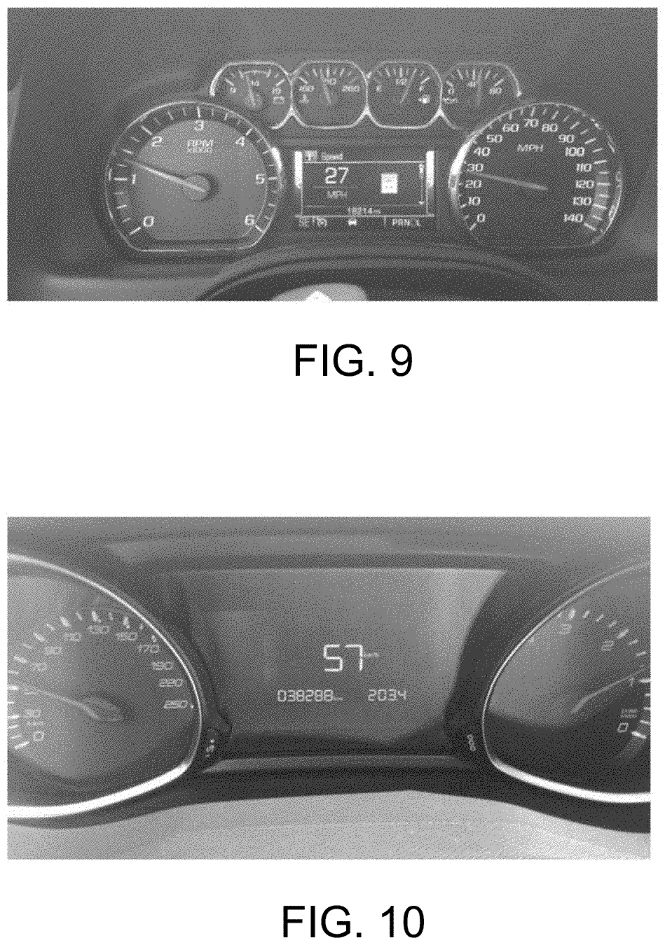

Referring to FIG. 8, the method 800 may include identifying one of the text strings as representing a measure of distance, at 802. For example, text strings representing a measure of distance may include “mi”, “km”, and the like. The method 800 may include selecting the text string nearest in the image to the identified text string, at 804. It is likely that the text string nearest “mi”, “km”, and the like in the image is a mileage. Referring again to FIG. 8, the method 800 may include obtaining a mileage from the identified and selected text strings, at 806. In the example of FIG. 9, the obtained mileage would be 18214 miles. In the example of FIG. 10, the obtained mileage would be 038288 kilometers.

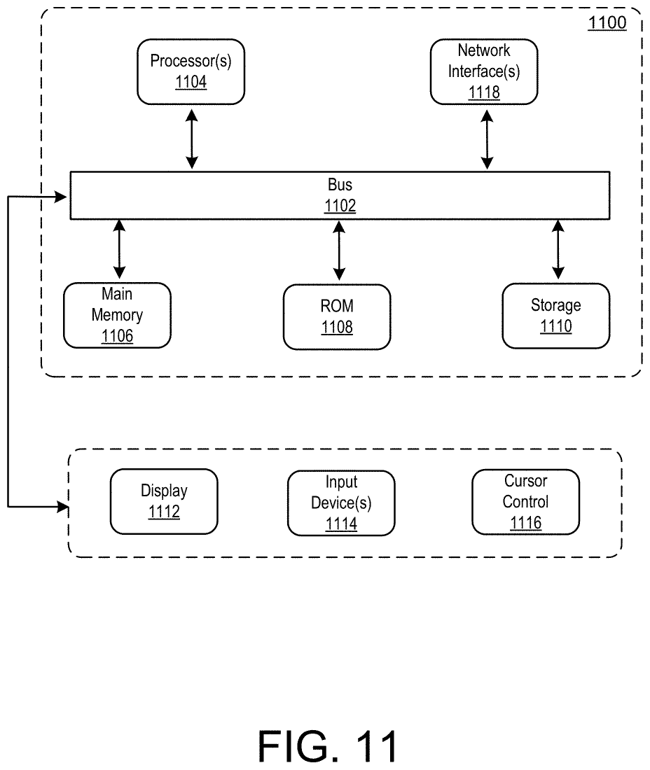

FIG. 11 depicts a block diagram of an example computer system 1100 in which embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the method steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a communication interface 1118 coupled to bus 1102. Network interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, network interface 1118 may be a local area network (LAN) card to provide a data communication connection to a compatible LAN (or a WAN component to communicate with a WAN). Wireless links may also be implemented. In any such implementation, network interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or method blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
obtaining an image related to a damaged vehicle;
determining an image type of the image, wherein the image type describes an item contained in the image;
extracting one or more images of text from the image;
extracting one or more text strings from each image of text;
identifying a type of each text string based on the determined image type;
obtaining a record, and for each text string: selecting a field of the record based on the identified type of the text string, and populating the selected field with the text string; and
determining an identity of the damaged vehicle based on the populated record.

2. The computer-implemented method of claim 1, further comprising:
obtaining insurance claim information for the damaged vehicle based on the determined identity of the damaged vehicle.

3. The computer-implemented method of claim 1, further comprising:
obtaining repair procedures for the damaged vehicle based on the determined identity of the damaged vehicle.

4. The computer-implemented method of claim 1, wherein:
the determined image type indicates the item is an insurance document; and
the method further comprises:
indexing a data dictionary with a test keyword comprising at least one of the text strings, wherein the data dictionary contains associations between keywords and names of insurance carriers, and
identifying an insurance carrier based on output generated by the data dictionary responsive to the indexing.

5. The computer-implemented method of claim 1, wherein:
the determined image type indicates the item is an insurance document;
the one or more text strings comprise multiple text strings; and
the method further comprises:
identifying a text string as containing a predetermined keyword,
determining a distance and/or direction from the identified text string to other text strings,
selecting a text string based on at least one of:
the distance and/or direction, and
the number of characters in the text string being below a threshold number; and
identifying an insurance policy number in the selected text string.

6. The computer-implemented method of claim 1, wherein:
the determined image type indicates the item is an insurance document;
the one or more text strings comprise multiple text strings; and
the method further comprises:
identifying a text string as containing a predetermined keyword,
determining a distance and/or direction from the identified text string to other text strings,
selecting a text string based on at least one of:
the distance and/or direction, and
the number of characters in the text string being above a threshold number; and
identifying a vehicle identification number in the selected text string.

7. The computer-implemented method of claim 1, wherein:
the determined image type indicates the item is a license plate;
the one or more text strings comprise multiple text strings; and
the method further comprises:
determining sizes of characters in the multiple text strings,
selecting text strings having the largest character size, and
obtaining a license plate number by concatenating the selected text strings.

8. The computer-implemented method of claim 1, wherein:
the determined image type indicates the item is an odometer;
the one or more text strings comprise multiple text strings; and
the method further comprises:
identifying one of the text strings as representing a measure of distance,
selecting the text string nearest in the image to the identified text string, and
obtaining a mileage from the identified and selected text strings.

9. The computer-implemented method of claim 1, wherein determining the image type of the image comprises:
providing the image as input to a machine learning model, wherein the machine learning model has been trained with images and corresponding image types; and
receiving output of the machine learning model responsive to the input, wherein the output comprises the determined image type of the image.

10. A system, comprising:
a hardware processor; and
a system encoded with instructions executable by the hardware processor to perform operations comprising:
obtaining an image related to a damaged vehicle;
determining an image type of the image, wherein the image type describes an item contained in the image;
extracting one or more images of text from the image;
extracting one or more text strings from each image of text;
identifying a type of each text string based on the determined image type;
obtaining a record, and for each text string: selecting a field of the record based on the identified type of the text string, and populating the selected field with the text string; and
determining an identity of the damaged vehicle based on the populated record.

11. The system of claim 10, the operations further comprising:
obtaining insurance claim information for the damaged vehicle based on the determined identity of the damaged vehicle.

12. The system of claim 10, the operations further comprising:
obtaining repair procedures for the damaged vehicle based on the determined identity of the damaged vehicle.

13. The system of claim 10, wherein:
the determined image type indicates the item is an insurance document; and
the operations further comprise:
indexing a data dictionary with a test keyword comprising at least one of the text strings, wherein the data dictionary contains associations between keywords and names of insurance carriers, and
identifying an insurance carrier based on output generated by the data dictionary responsive to the indexing.

14. The system of claim 10, wherein:
the determined image type indicates the item is an insurance document;
the one or more text strings comprise multiple text strings; and
the operations further comprise:
identifying a text string as containing a predetermined keyword,
determining a distance and/or direction from the identified text string to other text strings,
selecting a text string based on at least one of:
the distance and/or direction, and
the number of characters in the text string being below a threshold number; and
identifying an insurance policy number in the selected text string.

15. The system of claim 10, wherein:
the determined image type indicates the item is an insurance document;
the one or more text strings comprise multiple text strings; and
the operations further comprise:
identifying a text string as containing a predetermined keyword,
determining a distance and/or direction from the identified text string to other text strings,
selecting a text string based on at least one of:
the distance and/or direction, and
the number of characters in the text string being above a threshold number; and
identifying a vehicle identification number in the selected text string.

16. The system of claim 10, wherein:
the determined image type indicates the item is a license plate;
the one or more text strings comprise multiple text strings; and
the operations further comprise:
determining sizes of characters in the multiple text strings,
selecting text strings having the largest character size, and
obtaining a license plate number by concatenating the selected text strings.

17. The system of claim 10, wherein:
the determined image type indicates the item is an odometer;
the one or more text strings comprise multiple text strings; and
the operations further comprise:
identifying one of the text strings as representing a measure of distance,
selecting the text string nearest in the image to the identified text string, and
obtaining a mileage from the identified and selected text strings.

18. The system of claim 10, wherein determining the image type of the image comprises:
providing the image as input to a machine learning model, wherein the machine learning model has been trained with images and corresponding image types; and
receiving output of the machine learning model responsive to the input, wherein the output comprises the determined image type of the image.

19. A non-transitory machine-readable storage medium encoded with instructions executable by a hardware processor of a computing component, the machine-readable storage medium comprising instructions to cause the hardware processor to perform operations comprising:
obtaining an image related to a damaged vehicle;
determining an image type of the image, wherein the image type describes an item contained in the image;
extracting one or more images of text from the image;
extracting one or more text strings from each image of text;
identifying a type of each text string based on the determined image type;
obtaining a record, and for each text string: selecting a field of the record based on the identified type of the text string, and populating the selected field with the text string; and
determining an identity of the damaged vehicle based on the populated record.

20. The non-transitory machine-readable storage medium of claim 19, the operations further comprising:
obtaining insurance claim information for the damaged vehicle based on the determined identity of the damaged vehicle.

21. The non-transitory machine-readable storage medium of claim 19, the operations further comprising:
obtaining repair procedures for the damaged vehicle based on the determined identity of the damaged vehicle.

22. The non-transitory machine-readable storage medium of claim 19, wherein:
the determined image type indicates the item is an insurance document; and
the operations further comprise:
indexing a data dictionary with a test keyword comprising at least one of the text strings, wherein the data dictionary contains associations between keywords and names of insurance carriers, and
identifying an insurance carrier based on output generated by the data dictionary responsive to the indexing.

23. The non-transitory machine-readable storage medium of claim 19, wherein:
the determined image type indicates the item is an insurance document;
the one or more text strings comprise multiple text strings; and
the operations further comprise:
identifying a text string as containing a predetermined keyword,
determining a distance and/or direction from the identified text string to other text strings,
selecting a text string based on at least one of:
the distance and/or direction, and
the number of characters in the text string being below a threshold number; and
identifying an insurance policy number in the selected text string.

24. The non-transitory machine-readable storage medium of claim 19, wherein:
the determined image type indicates the item is an insurance document;
the one or more text strings comprise multiple text strings; and
the operations further comprise:
identifying a text string as containing a predetermined keyword,
determining a distance and/or direction from the identified text string to other text strings,
selecting a text string based on at least one of:
the distance and/or direction, and
the number of characters in the text string being above a threshold number; and
identifying a vehicle identification number in the selected text string.

25. The non-transitory machine-readable storage medium of claim 19, wherein:
the determined image type indicates the item is a license plate;
the one or more text strings comprise multiple text strings; and
the operations further comprise:
determining sizes of characters in the multiple text strings,
selecting text strings having the largest character size, and
obtaining a license plate number by concatenating the selected text strings.

26. The non-transitory machine-readable storage medium of claim 19, wherein:
the determined image type indicates the item is an odometer;
the one or more text strings comprise multiple text strings; and
the operations further comprise:
identifying one of the text strings as representing a measure of distance,
selecting the text string nearest in the image to the identified text string, and
obtaining a mileage from the identified and selected text strings.

27. The non-transitory machine-readable storage medium of claim 19, wherein determining the image type of the image comprises:
providing the image as input to a machine learning model, wherein the machine learning model has been trained with images and corresponding image types; and
receiving output of the machine learning model responsive to the input, wherein the output comprises the determined image type of the image.
